(19) United States
(12) Patent Application Publication
(10) Pub. No.: US 2014/0192415 A1
(43) Pub. Date: Jul. 10, 2014

(54) WINDOW FOR DISPLAY DEVICE AND DISPLAY DEVICE INCLUDING THE WINDOW

(71) Applicants: Yuki HONGO, Yongin-City (KR); Ju-Suk OH, Yongin-City (KR); Kwan-Young HAN, Yongin-City (KR)

(72) Inventors: Yuki HONGO, Yongin-City (KR); Ju-Suk OH, Yongin-City (KR); Kwan-Young HAN, Yongin-City (KR)

(21) Appl. No.: 13/935,722

(22) Filed: Jul. 5, 2013

(30) Foreign Application Priority Data
Jan. 8, 2013 (KR) 10-2013-0002170

(51) Int. Cl. G02B 1/11

(52) U.S. Cl. CPC G02B 1/111
USPC 359/609

(57) ABSTRACT

A window for a display device, the window including a first plastic substrate, a second plastic substrate adjacent to a surface of the first plastic substrate, the second plastic substrate including a polyester resin, a polyester urethane resin, or a combination thereof, a refractive index difference between the first plastic substrate and second plastic substrate being about 0.04 or less, and a third plastic substrate adjacent to a surface of the second plastic substrate.

### CROSS-REFERENCE TO RELATED APPLICATION

This application claims priority to and the benefit of Korean Patent Application No. 10-2013-0002170 filed in the Korean Intellectual Property Office on Jan. 8, 2013, the entire contents of which are incorporated herein by reference.

### BACKGROUND

1. Field

Embodiments relate to a window for a display device and a display device including the same.

2. Description of the Related Art

Display devices include a liquid crystal display (LCD), a plasma display panel (PDP), an organic light emitting diode display (OLED), a field emission display (FED), an electrophoretic display device, and the like.

### SUMMARY

Embodiments are directed to a window for a display device, the window including a first plastic substrate, a second plastic substrate adjacent to a surface of the first plastic substrate, the second plastic substrate including a polyester resin, a polyester urethane resin, or a combination thereof, a refractive index difference between the first plastic substrate and second plastic substrate being about 0.04 or less, and a third plastic substrate adjacent to a surface of the second plastic substrate.

A refractive index difference between the second plastic substrate and third plastic substrate may be about 0.04 or less.

The second plastic substrate may have a refractive index of about 1.50 to about 1.60.

The second plastic substrate may have a thickness of about 5 μm to about 80 μm.

The first plastic substrate may include polycarbonate, polymethyl methacrylate, cyclic olefin, a copolymer thereof, or a combination thereof.

The third plastic substrate may include an ultraviolet (UV) curable resin.

The third plastic substrate may include an acryl-based compound, an epoxy-based compound, or a combination thereof.

The third plastic substrate may include a filler.

The filler may include silica, alumina, mica, glass beads, titania, iron oxide, or a combination thereof.

The first plastic substrate may have a thickness of about 400 μm to about 800 μm.

The third plastic substrate may have a thickness of about 5 μm to about 100 μm.

The window may have a surface haze of about 1.0% or less.

The second plastic substrate may be interposed between the first plastic substrate and the third plastic substrate.

The second plastic substrate may directly contact the first plastic substrate and the third plastic substrate.

Embodiments are also directed to a display device, including a display panel, and a window according to an embodiment, the window being disposed on one side of the display panel.

### BRIEF DESCRIPTION OF THE DRAWING

FIG. 1 is a cross-sectional view showing a window for a display device according to an example embodiment.

### DETAILED DESCRIPTION

The present disclosure will be described more fully hereinafter with reference to the accompanying drawings, in which example embodiments of this disclosure are shown.

This disclosure may, however, be embodied in many different forms and is not construed as limited to the example embodiments set forth herein.

In the drawings, the thickness of layers, films, panels, regions, etc., are exaggerated for clarity.

Like reference numerals designate like elements throughout the specification.

It will be understood that when an element such as a layer, film, region, or substrate is referred to as being “on” another element, it can be directly on the other element or intervening elements may also be present.

In contrast, when an element is referred to as being “directly on” another element, there are no intervening elements present.

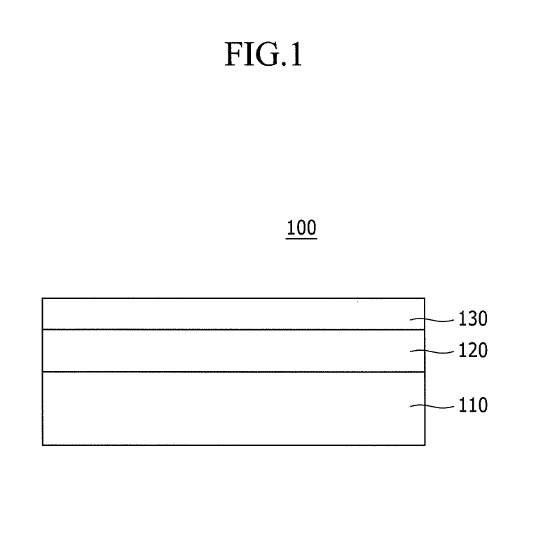

FIG. 1 is a cross-sectional view showing a window for a display device according to an example embodiment.

In the example embodiment shown in FIG. 1, a window 100 for a display device includes a first plastic substrate 110, a second plastic substrate 120 disposed on one side of the first plastic substrate 110, and a third plastic substrate 130 disposed on one side of the second plastic substrate 120.

The first plastic substrate 110 may be made of a polymer compound, for example, polyimide, polyacrylate, polyethylene etherphthalate, polyethylene naphthalate, polycarbonate, polyarylate, polyetherimide, polyethersulfone, polymethylmethacrylate, triacetylcellulose, poly vinylidene chloride, poly vinylidene fluoride, polyester, cyclic olefin, a copolymer thereof, or a combination thereof.

In an example embodiment, among these materials, the polycarbonate, polymethylmethacrylate, a cyclicolefin polymer, a copolymer thereof, or a combination thereof may be selected for their heat resistance.

The first plastic substrate 110 may be formed by injection-molding a plastic resin into various shapes.

The first plastic substrate 110 may have a refractive index of about 1.47 to about 1.60, e.g., about 1.49 to about 1.58.

In this specification, the refractive index is measured by using an Abbe refractometer (DR-M2, ATAGO Inc.).

The first plastic substrate 110 may have a thickness of about 400 μm to about 800 μm.

When the first plastic substrate 110 has a thickness within the range, the first plastic substrate may be fabricated into a thin film and sufficiently protect the display panel.

The second plastic substrate 120 may include a polyester resin, a polyester urethane resin, or a combination thereof.

The polyester resin and the polyester urethane resin have relatively high hardness among transparent polymers.

The second plastic substrate 120 may include a polyester resin, a polyester urethane resin, or a combination thereof, and thus may decrease a bending phenomenon of a window for a display device.

The second plastic substrate 120 may be relatively thin while sufficiently supporting the third plastic substrate 130, and thus may realize a window 100 for a display device as a thin film.

The second plastic substrate 120 may have a thickness of about 5 μm to about 80 μm.

When the second plastic substrate 120 has a thickness of less than 5 μm, the second plastic substrate may have low strength and decrease manufacturing efficiency. On the other hand, when the second plastic substrate has a thickness of greater than 80 μm, it may not be preferable in terms of a thin film.

The first plastic substrate 110 and the second plastic substrate 120 may have a refractive index difference between about 0.04 or less.

In this specification, the refractive index difference indicates an absolute value.

When the first plastic substrate 110 and the second plastic substrate 120 have a refractive index difference of about 0.04 or less, the first plastic substrate 110 and the second plastic substrate 120 may suppress an interface reflection, and thus may improve an appearance characteristic of the window 100 for a display device.

The first plastic substrate 110 and second plastic substrate 120 may have a refractive index difference of less than or equal to about 0.03, e.g., less than or equal to about 0.02, or less than or equal to about 0.01.

A smaller refractive index difference may be desirable. When the refractive index difference is about 0, the first plastic substrate 110 and the second plastic substrate 120 may exhibit no interface reflection.

The second plastic substrate 120 may have a refractive index of about 1.50 to about 1.60, e.g., about 1.52 to about 1.56.

When the second plastic substrate 120 has a refractive index within the range, the second plastic substrate 120 may minimize a refractive index difference with the first plastic substrate 110 and another refractive index difference with the third plastic substrate 130 that will be described below.

Accordingly, the window 100 for a display device may minimize discoloring of a reflection light on the surface thereof and improve high quality appearance of the window 100 for a display device.

The second plastic substrate 120 may be disposed to face one side of the first plastic substrate 110.

In the example embodiment described above, the second plastic substrate 120 includes a polyester resin, a polyester urethane resin, or a combination thereof, and may exhibit excellent characteristics when closely contacting with the first plastic substrate 110.

The second plastic substrate 120 may be directly disposed on the first plastic substrate 110 without a bonding layer such as a binder layer therebetween.

The window 100 for a display device may be fabricated into a thin film.

In the example embodiment described above, the third plastic substrate 130 is disposed on one side of the second plastic substrate 120. In an example embodiment, the third plastic substrate has a refractive index difference of about 0.04 or less with the second plastic substrate 120.

When the third plastic substrate 130 has a refractive index difference of about 0.04 or less with the second plastic substrate 120, the third and second plastic substrates 130 and 120 may suppress interface reflection, and thus may improve appearance characteristics of the window 100 for a display device.

The third plastic substrate 130 may have a refractive index difference of less than or equal to about 0.03, less than or equal to about 0.02, or less than or equal to about 0.01 with the second plastic substrate 120.

A smaller refractive index difference may be desirable. When the refractive index difference is 0, the second plastic substrate 120 and the third plastic substrate 130 may exhibit no interface reflection.

The third plastic substrate 130 may have a refractive index of about 1.47 to about 1.64, e.g., about 1.49 to about 1.60.

The third plastic substrate 130 may include an ultraviolet (UV) curable resin.

The third plastic substrate 130 may further include a photopolymerization initiator along with the ultraviolet (UV) curable resin.

The photopolymerization initiator may include, for example, an acetophenone-based compound or a benzophenone-based compound, but is not limited thereto.

The third plastic substrate 130 may include an acryl-based compound, an epoxy-based compound, or a combination thereof.

In an example embodiment, the acryl-based compound may be preferable in terms of transparency and surface hardness.

The third plastic substrate 130 may further include a filler.

The filler may include silica, alumina, mica, glass beads, titania, iron oxide, or a combination thereof.

The silica may be desirable in terms of light transmittance among the aforementioned materials.

The third plastic substrate 130 may have a thickness of about 5 μm to about 100 μm.

When the third plastic substrate 130 has a thickness within the range, the window 100 for a display device may be thin and simultaneously have a desirable surface hardness.

The window 100 for a display device may have a surface haze of less than about 1.0%.

Herein, the haze may be measured using a hazemeter (NDH-5000, Nippondenshoku Industries Co. Ltd.).

When the haze is within the range, desired visibility may be provided.

Hereinafter, a method of manufacturing the window for a display device according to an example embodiment will be described.

According to the present example embodiment, the manufacturing method may include preparing a second plastic substrate (a); forming a third plastic substrate on one side of the second plastic substrate (b); and forming a first plastic substrate on the other side of the second plastic substrate (c).

In the present example embodiment, the second plastic substrate (a) is prepared by coating and drying the second plastic substrate on one side of a peeling film.

The peeling film may have peeling property on the side and include, for example, polyethylene terephthalate, polyethylene, polypropylene, polyvinyl chloride, a copolymer thereof, or a combination thereof, but is not limited thereto.

The second plastic substrate may be formed of the material described above.

The coating of the second plastic substrate may be performed, for example, in a solution process such as spin coating, slit-coating, screen printing, inkjet, ODF (one drop filling), or a combination thereof.

The second plastic substrate may be further radiated by ultraviolet (UV) if desired after coating and drying the solution.

The formation (b) of the third plastic substrate may be performed by coating and drying the third plastic substrate on one surface of the second plastic substrate.

The third plastic substrate may be formed of the material described above.

The coating and drying is the same as coating and drying the second plastic substrate on the peeling film, and thus details thereof will not be repeated.

The third plastic substrate may be cured by radiating ultraviolet (UV) after the drying.

The formation (c) of the first plastic substrate on the other side of the second plastic substrate is performed by removing the peeling film from one side of the second plastic substrate.

Then, the second plastic substrate is applied to one side of the first plastic substrate after removing the peeling film therefrom and then, injection-molded into a window for a display device.

The above-described window panel may be applied for various display devices.

The window panel may be disposed on a display panel, and the display panel may be a liquid crystal panel, an organic light emitting panel, a plasma display panel, an electric field effect display panel, an electrophoresis display panel, and the like.

The following examples illustrate aspects of example embodiments in more detail.

These examples, however, are not in any sense to be interpreted as limiting the scope of this disclosure.

Manufacture of Window for Display Device

### Example 1

A polyester resin was coated and dried on a 30 μm-thick polyethylene terephthalate (PET) film attached with a peeling layer, forming a second plastic substrate.

The second plastic substrate had a refractive index of 1.56 and a thickness of 20 μm.

Next, an acryl resin was coated and dried on the second plastic substrate and cure by radiating ultraviolet (UV) light thereon.

The obtained third plastic substrate had a refractive index of 1.53 and a thickness of 10 μm.

Then, the PET film attached with the peeling layer was peeled off from the second plastic substrate, and the resulting product was injection-molded in an injection molder with a polycarbonate resin (a first plastic substrate material), fabricating a window for a display device.

The first plastic substrate had a refractive index of 1.58 and a thickness of 600 μm.

### Example 2

A window for a display device was fabricated according to the same method as Example 1 except for using a polyester urethane resin instead of the polyester resin and polymethylmethacrylate (PMMA) instead of the polycarbonate resin.

The first plastic substrate had a refractive index of 1.49, and the second plastic substrate had a refractive index of 1.52.

### Example 3

A window for a display device was fabricated according to the same method as Example 2 except for adding SiO₂ to an acryl resin.

The third plastic substrate included therein had a refractive index of 1.49.

### Comparative Example 1

An acryl resin was coated to be 10 μm thick on one surface of a 100 μm-thick polyethylene terephthalate (PET) substrate and cured by radiating ultraviolet (UV) thereon.

Herein, the PET film had a refractive index of 1.65, and the acryl resin had a refractive index of 1.53.

A 5 μm-thick binder layer was formed on the other surface of the PET film.

The binder layer had a refractive index of 1.51.

The PET film was inserted in an injection molder and injection-molded into a 600 μm-thick polycarbonate resin layer, fabricating a window for a display device.

The polycarbonate resin layer had a refractive index of 1.58.

Appearance of Window for Display Device

The windows for a display device according to Examples 1 to 3 and Comparative Example 1 were painted with an oil-based black pen on the first plastic substrate, and the third plastic substrate was examined with naked eyes using a reflection light under a fluorescent lamp with 3 wavelengths.

The fluorescent lamp was 1 m away from the windows.

The windows were evaluated regarding appearance compared with a soda glass having a refractive index of 1.51 as follows.

O: equivalent reflection light of a window to that of the soda glass

x: reflection light of a window has been colored

Haze of Window for Display Device

The windows were measured regarding haze using a haze-meter (NDH-5000, Nippondenshoku Industries Co. Ltd.).

The appearance and haze evaluation results are provided in the following Table 1.

TABLE 1

| | | | Second | | | | | | Total |
|---|---|---|---|---|---|---|---|---|---|
| | First plastic | | plastic | | Third plastic | | | | thickness of |
| | substrate | | substrate | | substrate | | | | window |
| | Material | η | Material | η | Material | η | Appearance | Haze | (μm) |
| Ex. 1 | PC | 1.58 | PEs | 1.56 | AC | 1.53 | ◯ | 0.7 | 630 |
| Ex. 2 | PMMA | 1.49 | PEsU | 1.52 | AC | 1.53 | ◯ | 0.6 | 630 |
| Ex. 3 | PMMA | 1.49 | PEsU | 1.52 | AC, SiO₂ | 1.49 | ◯ | 0.6 | 630 |
| Comp. | PC | 1.58 | PET | 1.65 | AC | 1.53 | X | 0.6 | 715 |
| Ex. 1 | | | | | | | | | |

(η—refractive index, AC: acryl resin, PEs: polyester resin, PEsU: polyester urethane resin, PMMA: polymethylmethacrylate, PC: polycarbonate resin)

Referring to Table 1, the windows for a display device according to Examples 1 to 3 had an equivalent reflection light to that of the soda glass, while the window for a display device according to Comparative Example 1 had a colored reflection light.

The windows for a display device according to Examples 1 to 3 had an equivalent high quality appearance to that of the glass window.

In addition, the windows for a display device according to Examples 1 to 3 respectively had a thickness of 630 μm, which is significantly thinner than the 715 μm thickness of the window according to Comparative Example 1.

By way of summation and review, a display device may include a display module displaying an image and a window panel protecting the display module. The window panel may be fabricated by using, e.g., a single plastic substrate, two or more kinds of plastic substrates, etc. However, the window formed of more than two kinds of plastic substrates may exhibit undesirable characteristics if the kinds of plastic substrates have significantly different characteristics.

As described above, embodiments may provide a window for a display device. The window may exhibit excellent appearance characteristics and may include two or more kinds of plastic substrates adhered together. Another embodiment provides a display device including the window for a display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: window for a display device
110: first plastic substrate
120: second plastic substrate
130: third plastic substrate

What is claimed is:

1. A window for a display device, the window comprising:
a first plastic substrate;
a second plastic substrate adjacent to a surface of the first plastic substrate, the second plastic substrate including a polyester resin, a polyester urethane resin, or a combination thereof, a refractive index difference between the first plastic substrate and second plastic substrate being about 0.04 or less; and
a third plastic substrate adjacent to a surface of the second plastic substrate.

2. The window as claimed in claim 1, wherein a refractive index difference between the second plastic substrate and third plastic substrate is about 0.04 or less.

3. The window as claimed in claim 1, wherein the second plastic substrate has a refractive index of about 1.50 to about 1.60.

4. The window as claimed in claim 1, wherein the second plastic substrate has a thickness of about 5 μm to about 80 μm.

5. The window as claimed in claim 1, wherein the first plastic substrate includes polycarbonate, polymethyl methacrylate, cyclic olefin, a copolymer thereof, or a combination thereof.

6. The window as claimed in claim 1, wherein the third plastic substrate includes an ultraviolet (UV) curable resin.

7. The window as claimed in claim 6, wherein the third plastic substrate includes an acryl-based compound, an epoxy-based compound, or a combination thereof

8. The window as claimed in claim 6, wherein the third plastic substrate includes a filler.

9. The window as claimed in claim 8, wherein the filler includes silica, alumina, mica, glass beads, titania, iron oxide, or a combination thereof.

10. The window as claimed in claim 1, wherein the first plastic substrate has a thickness of about 400 μm to about 800 μm.

11. The window as claimed in claim 1, wherein the third plastic substrate has a thickness of about 5 μm to about 100 μm.

12. The window as claimed in claim 1, wherein the window has a surface haze of about 1.0% or less.

13. The window as claimed in claim 1, wherein the second plastic substrate is interposed between the first plastic substrate and the third plastic substrate.

14. The window as claimed in claim 13, wherein the second plastic substrate directly contacts the first plastic substrate and the third plastic substrate.

15. A display device, comprising:
a display panel; and
the window as claimed in claim 1, the window being disposed on one side of the display panel.
